(19) United States
(12) Patent Application Publication
(10) Pub. No.: US 2026/0352839 A1
(43) Pub. Date: Nov. 5, 2026

(54) VIDEO PROCESSING METHOD AND APPARATUS, AND ELECTRONIC DEVICE

(71) Applicant: Beijing Zitiao Network Technology Co., Ltd., Beijing (CN)

(72) Inventor: Mingjin CHEN, Beijing (CN)

(21) Appl. No.: 19/488,533

(22) PCT Filed: May 24, 2024
(86) PCT No.: PCT/CN2024/095201

§ 371 Date: Nov. 26, 2025

(30) Foreign Application Priority Data
May 31, 2023 (CN) 202310632275.6

(51) Int. Cl. H04N 19/146; H04N 19/14; H04N 19/172; H04N 19/182

(52) U.S. Cl. CPC H04N 19/146; H04N 19/14; H04N 19/172; H04N 19/182

(57) ABSTRACT

The present disclosure provides a video processing method and apparatus, and an electronic device. One specific embodiment of the method comprises: acquiring current image feature data of a video, wherein the image feature data represents the image complexity of the video; acquiring a frame rate corresponding to the video; and adjusting the current bit rate of the video on the basis of the image feature data and the frame rate, so that the current bit rate of the video is positively correlated with the image complexity of the video.

### CROSS-REFERENCE TO RELATED APPLICATIONS

The present application is based on and claims priority to Chinese Application No. 202310632275.6 filed on May 31, 2023, the disclosure of which is incorporated by reference herein into the present application in its entirety.

### TECHNICAL FIELD

The present disclosure relates to the video processing technical field, and in particular a video processing method and apparatus, and an electronic device.

### BACKGROUND

With the continuous development of network technologies and streaming media technologies, videos are more and more used in people's lives, providing entertainment services for people's lives and bringing a lot of convenience. At present, in the process of uploading or playing videos, there are usually instability problems in the speed and smoothness of processing for videos and the quality of videos. Therefore, an effective video processing method is needed.

### SUMMARY

The present disclosure provides a video processing method and apparatus, and an electronic device.

According to a first aspect, there is provided a video processing method, the method comprising:
acquiring current image feature data of a video, wherein the image feature data represents an image complexity degree of the video;
acquiring a frame rate corresponding to the video;
adjusting a current code rate of the video based on the image feature data and the frame rate, so that the current code rate of the video is positively correlated with the image complexity degree of the video.

According to a second aspect, there is provided a video processing apparatus, the apparatus comprising:
a first acquisition module for acquiring current image feature data of a video, wherein the image feature data represents the image complexity degree of the video;
a second acquisition module for acquiring a frame rate corresponding to the video;
an adjustment module for adjusting a current code rate of the video based on the image feature data and the frame rate, so that the current code rate of the video is positively correlated with the image complexity degree of the video.

According to a third aspect, there is provided a computer-readable storage medium having a computer program stored thereon, which, when executed by a processor, implements the method in any one of the above aspect.

According to a fourth aspect, there is provided an electronic device comprising a memory, a processor, and a computer program which is stored in the memory and executable on the processor, which, when executed by the processor, implements the method in any one of the first aspect.

It is to be understood that both the foregoing general description and the following detailed description are exemplary and explanatory only and are not limiting the present disclosure.

### BRIEF DESCRIPTION OF THE DRAWINGS

In order to explain the technical solution of the embodiments in the present Specification more clearly, the Drawings needed in the description of the embodiments will be briefly introduced below. Obviously, the Drawings in the following description are only some embodiments recited in the present Specification. For those skilled in the art, other drawings can be obtained according to these drawings without inventive effort.

FIG. 1 is a schematic diagram of a video processing scene shown according to an exemplary embodiment;

FIG. 2 is a flow diagram of a video processing method shown according to an exemplary embodiment of the present disclosure;

FIG. 3A is a schematic diagram of a video processing scene shown according to an exemplary embodiment of the present disclosure;

FIG. 3B is a schematic diagram of another video processing scene shown according to an exemplary embodiment of the present disclosure;

FIG. 4 is a flow diagram of another video processing method shown according to an exemplary embodiment of the present disclosure;

FIG. 5 is a block diagram of a video processing apparatus shown according to an exemplary embodiment of the present disclosure;

FIG. 6 is a schematic block diagram of an electronic device provided by some embodiments of the present disclosure;

FIG. 7 is a schematic block diagram of another electronic device provided by some embodiments of the present disclosure;

FIG. 8 is a schematic diagram of a storage medium provided by some embodiments of the present disclosure.

### DETAILED DESCRIPTION

In order to make those skilled in the art better understand the technical solution in the present Specification, the technical solution in the embodiments of the present Specification will be described clearly and completely with the attached drawings in the embodiments of the present Specification. Obviously, the described embodiments are only a part of the embodiments of the present Specification, but not all the embodiments. Based on the embodiments in the present Specification, all other embodiments obtained by those skilled in the art without inventive effort should belong to the protection scope in the present Specification.

When the following description refers to the drawings, unless otherwise indicated, the same numbers in different drawings indicate the same or similar elements. The implementations described in the following exemplary embodiments do not represent all implementations consistent with the present disclosure. Rather, they are merely examples of the apparatus and method consistent with some aspects of the present disclosure as detailed in the appended Claims.

The terms used in the present disclosure are for the purpose of describing specific embodiments only and are not intended to limit the present disclosure. The singular forms “a”, “the” and “said” used in the present disclosure are also intended to include the plural forms, unless the context clearly indicates other meaning. It should also be understood that the term “and/or” as used herein refers to and includes any or all possible combinations of one or more associated listed items.

It should be understood that although the terms such as first, second, and third may be used to describe various information in the present disclosure, these information should not be limited to these terms. These terms are only used to distinguish the same type of information from each other. For example, without departing from the scope of the present disclosure, the first information can also be called the second information, and similarly, the second information can also be called the first information. Depending on the context, the word “if” as used herein can be interpreted as “when” or “in response to determining”.

At present, in the process of uploading or playing videos, it is necessary to perform encoding processing for the videos. Therefore, it is necessary to allocate a code rate (i.e., the data amount of video images processed per unit time) to an application that performs encoding processing. In the related art, for videos with the same resolution, the same bit rate is generally set, which can be the optimal bit rate for the global. However, the inventor of the present disclosure has found that there are instability problems in the speed and smoothness of encoding processing for videos, and the quality of videos will be reduced. The reason for the above problems is that the image complexity degree in videos may change greatly, while the code rate value is always fixed.

According to the video processing solution provided by the present disclosure, the current code rate of the video is adjusted based on the image feature data representing the current image complexity degree of the video and the frame rate corresponding to the video, so that the current code rate of the video is positively correlated with the image complexity degree of the video. The code rate of video processing changes with the image complexity degree of the video, which thus not only makes the speed and smoothness of encoding processing for the video and the quality of the video more stable, but also improves the utilization rate of image processing resources.

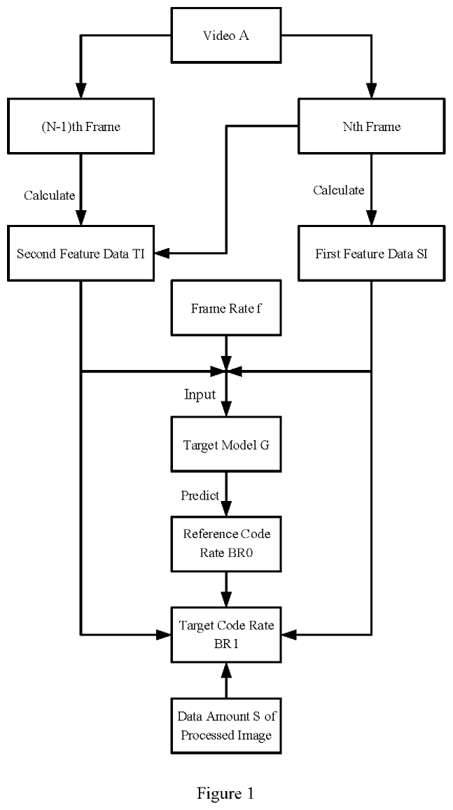

FIG. 1 is a schematic diagram of a video processing scene shown according to an exemplary embodiment.

As shown in FIG. 1, in the process of processing video A, if the N-th frame of image is currently being processed, it is possible to calculate current first feature data SI of video A based on the N-th frame of image, and calculate current second feature data TI of video A based on the N-th frame of image and the (N−1)th frame of image, wherein the first feature data SI can represent the current image complexity degree of the video, and the second feature data TI can represent the current image inter-frame variation degree of the video.

Next, it is possible to input the first feature data SI, the second feature data TI and the frame rate f preset for video A into a pre-trained target model G, whereby to predict reference code rate BR0; then acquire the data amount S of the processed previous N−1 frames of image; finally, determine the final target code rate BR1 based on the first feature data SI, the second feature data TI, the data amount S of the processed previous N−1 frames of image and the reference code rate BR0, and adjust the current code rate of video A to the target code rate BR1.

The present disclosure will be described in detail in combination with a specific embodiment.

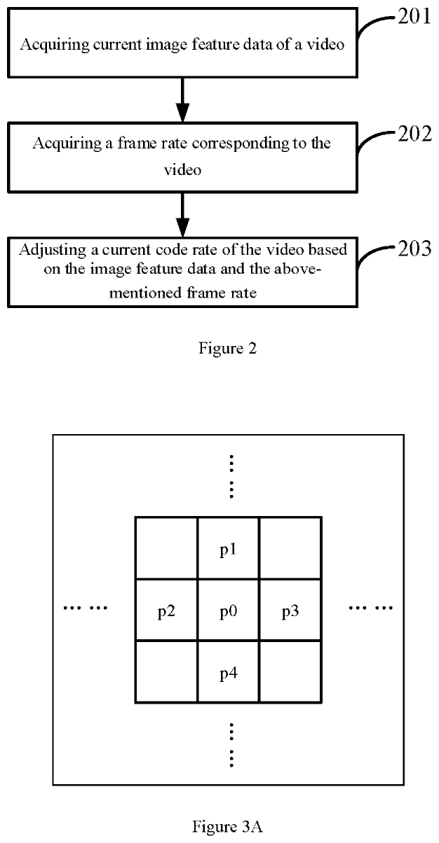

FIG. 2 is a flow diagram of a video processing method shown according to an exemplary embodiment. The execution subject of this method can be implemented as any device, platform, server or device cluster with computing and processing capabilities. The method includes the following steps.

As shown in FIG. 2, in step 201, acquiring current image feature data of a video.

In the present embodiment, the video involved can be a video being processed (such as encoding processing), for example, the video can be a video being uploaded or a video being played. In the process of processing the video, it is possible to acquire the current image feature data of the video, for example, it is possible to acquire the current image feature data of the video when processing each frame of image, it is also possible to acquire the current image feature data of the video every preset number of frames of image, and it is also possible to periodically acquire the current image feature data of the video. It can be understood that the specific timing of acquiring image feature data is not limited by the present embodiment.

In the present embodiment, the image feature data can be data representing the image complexity degree of the video. For example, the image feature data can include first feature data representing the current image complexity degree of the video, and/or second feature data representing the current image inter-frame variation degree of the video. It can be understood that the image feature data can also include other data that can represent the image complexity degree of the video, and the specific content included in the image feature data is not limited by the present embodiment.

In the present embodiment, if the image feature data includes the first feature data, it is possible to acquire a current frame of image of the video, so as to determine the first feature data that can represent the current image complexity degree of the video based on each pixel of the current frame of image. Specifically, it is possible to determine the first feature data based on the pixel value differences between a plurality of pixels and neighboring pixels in the current frame of image.

In one implementation, for any pixel in the current frame of image, the sum of the pixel value differences between the pixel and the neighboring pixels can be calculated. For example, as shown in FIG. 3A, p0 is any pixel in the current frame of image, and p1, p2, p3, and p4 are neighboring pixels of p0, respectively, and S=(m0−m1)+(m0−m2)+(m0−m3)+(m0−m4) can be calculated, where m0, ml, m2, m3, and m4 are pixel values of the pixels p0, p1, p2, p3, and p4, respectively, and S represents the sum of the pixel value differences between the pixel p0 and the neighboring pixels. After calculating the sum of the pixel value differences between each of part or all of the pixels and the neighboring pixels in the current frame of image, the first feature data can be determined based on the calculation results. For example, the standard deviation of the sum of the pixel value differences between each of the above-mentioned part or all of the pixels and the neighboring pixels can be calculated as the first feature data SI.

In another implementation, for any pixel in the current frame of image, it is also possible to calculate the average value of the pixel value differences between the pixel and the neighboring pixels, and calculate the standard deviation of the average value of the pixel value differences between each pixel of part or all of the pixels and the neighboring pixels in the current frame of image as the first feature data. It can be understood that it is also possible to determine the first feature data in any other reasonable way, which is not limited by the present embodiment.

In the present embodiment, if the image feature data includes the second feature data, it is possible to acquire the current frame of image and the previous frame of image of the video, so as to determine the second feature data that can represent the current image inter-frame variation degree of the video and based on each pixel of the current frame of image and the previous frame of image. Specifically, it is possible to determine the second feature data based on the pixel value differences between the pixels at the same position in the current frame of image and the previous frame of image.

In one implementation, it is possible to calculate the sum of the pixel value differences between the pixels at the same position in the current frame of image and the previous frame of image. For example, as shown in FIG. 3B, p0, p1, p2 and p3 are pixels in the current frame of image respectively, and their coordinates are (x0,y0) (x1,y1) (x2,y2) (x3,y3) respectively; p4, p5, p6 and p7 are pixels in the previous frame of image respectively, and their coordinates are also (x0,y0) (x1,y1) (x2,y2) (x3,y3) respectively. T=(m0−m4)+(m1−m5)+(m2−m6)+(m3−m7) can be calculated, where m0, m1, m2, m3, m4, m5, m6 and m7 are pixel values of the pixels p0, p1, p2, p3, p4, p5, p6 and p7 respectively, and T represents the sum of the pixel value differences between the pixels at the same position in the current frame of image and the previous frame of image. After calculating the sum of part or all of the pixel value differences between the pixels at the same position in the current frame of image and the previous frame of image, it is possible to determine the second feature data based on the calculation result. For example, it is possible to calculate the standard deviation of the sum of the above-mentioned part or all of the pixel value differences between the pixels at the same position as the second feature data TI. It can be understood that it is also possible to determine the second feature data in any other reasonable way, which is not limited by the present embodiment.

In step 202, acquiring a frame rate corresponding to the video; and in step 203, adjusting a current code rate of the video based on the image feature data and the above-mentioned frame rate.

In the present embodiment, in the process of processing the video, the number of frames of the video image processed per unit time can be represented by the frame rate, and the data amount of the video image processed per unit time can be represented by the code rate. In the video processing process, the frame rate remains unchanged while the code rate can be adjusted at any time. The frame rate and code rate corresponding to the video jointly affect quality of the video, so the current code rate of the video can be adjusted at any time based on the image feature data and the above-mentioned frame rate. Moreover, the current code rate of the video is positively correlated with the image complexity degree of the video.

For example, when it is determined that the image complexity degree of the video increases based on the current image feature data of the video, the current bit rate of the video can be increased according to the frame rate corresponding to the video; when it is determined that the image complexity degree of the video decreases based on the current image feature data of the video, the current code rate of the video can be decreased according to the frame rate corresponding to the video, so that the code rate of the video changes with the image complexity degree of the video.

According to the video processing method provided by the present disclosure, the current code rate of the video is adjusted based on the image feature data representing the current image complexity degree of the video and the frame rate corresponding to the video, so that the current code rate of the video is positively correlated with the image complexity degree of the video. The code rate of video processing changes with the image complexity degree of the video, which thus not only makes the speed and smoothness of encoding processing for the video and the quality of the video more stable, but also improves the utilization rate of image processing resources.

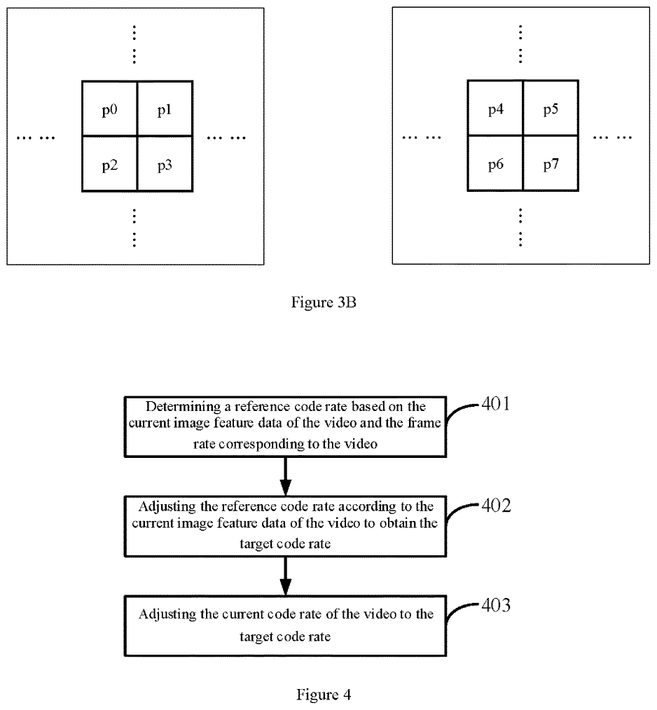

FIG. 4 is a flow diagram of another video processing method shown according to an exemplary embodiment, which describes the process of adjusting the current code rate of the video, including the following steps.

As shown in FIG. 4, in step 401, determining a reference code rate based on the current image feature data of the video and the frame rate corresponding to the video.

In the present embodiment, it is possible to preliminarily determine the reference code rate based on the current image feature data of the video and the frame rate corresponding to the video. Specifically, it is possible to input the current image feature data of the video and the frame rate corresponding to the video into a pre-trained target model, whereby to predict the reference code rate.

For example, when training the target model, it is possible to collect a number of sample videos with different contents, process each sample video with a different bit rate respectively, and calculate the quality index of the video processed with the different bit rate; meanwhile, calculate the image feature data corresponding to each frame of each sample video to obtain a training set; then use the training set to fit the relationship among the image feature data, the frame rate, the code rate and the quality index of the video by machine learning, so as to obtain the target model. When using the target model, it is possible to input the current image feature data of the video and the frame rate corresponding to the video into the target model to obtain the code rates meeting different quality indexes, and it is possible to acquire the minimum code rate meeting the preset quality index as the reference code rate.

In step 402, adjusting the reference code rate according to the current image feature data of the video to obtain the target code rate, and in step 403, adjusting the current code rate of the video to the target code rate.

In the present embodiment, it is possible to further adjust the reference code rate according to the current image feature data of the video to obtain the target code rate, so that the target code rate is more suitable for video processing. Specifically, whether the current image of the video meets the conditions of a complex image can be determined based on the current image feature data of the video. When the current image of the video does not meet the conditions of the complex image, the reference code rate is taken as the target code rate. When the current image of the video meets the conditions of the complex image, the reference code rate can be directly increased to obtain the target code rate. Alternatively, the data amount of the processed image corresponding to the video can be further determined. If the data amount of the processed image is greater than the specified data amount, the reference code rate is still taken as the target code rate; if the data amount of the processed image is less than or equal to the specified data amount, then the reference code rate is increased to obtain the target code rate.

On the one hand, the data amount of the processed image corresponding to the video can include the sum of the data amounts of all the images before the current frame of image of the video. For example, if the N-th frame of image of the video is currently being processed, the data amount of the processed image corresponding to the video can be the total sum of the data amounts of the previous N−1 frame of images. On the other hand, the specified data amount can be the processing size theoretically accumulated by processing the previous N−1 frame of images according to the reference code rate. For example, the specified data amount can be represented by the following formula:

M=BR0(N−1)/f
where M represents the specified data amount, BR0 represents the reference code rate, N−1 represents the number of frames of the processed image, and f represents the frame rate corresponding to the video.

The present embodiment can further increase the predicted reference code rate when the data amount of the processed image corresponding to the video is small, so that a greater code rate is currently allocated to the video, so as to further improve the quality of the video.

In some embodiments, if the data amount of the processed image is less than or equal to the specified data amount, it is possible to determine the code rate increment based on the data amount of the processed image, and determine the sum of the reference code rate and the code rate increment as the target code rate. The code rate increment is negatively correlated with the data amount of the processed image, so that the greater the data amount of the processed image, the smaller the code rate increment, and the smaller the data amount of the processed image, the greater the code rate increment. For example, the target code rate can be calculated by the following formula:

BR1=[BR0*(N−1)/f−S]/f+BR0
where BR1 represents the target code rate, [BR0*(N−1)/f−S]/f represents the code rate increment, BR0 represents the reference code rate, N−1 represents the number of frames of the processed image, f represents the frame rate corresponding to the video, and S represents the data amount of the processed N−1 frames of images.

The present embodiment can further increase the predicted reference code rate when the data amount of the processed image corresponding to the video is small, and the code rate increment is negatively correlated with the data amount of the processed image, so that the target code rate currently allocated to the video is more reasonable.

It can be understood that it is also possible to increase the reference code rate so as to obtain the target code rate in any other reasonable way, and the specific way to determine the target code rate is not limited by the present embodiment.

It should be noted that whether the current image of the video meets the conditions of the complex image can be determined in the following way.

If the image feature data only includes the first feature data, when the first feature data is greater than the first preset threshold, it can be determined that the current image of the video meets the conditions of the complex image; when the first feature data is less than or equal to the first preset threshold, it can be determined that the current image of the video does not meet the conditions of the complex image.

If the image feature data only includes the second feature data, when the second feature data is greater than the second preset threshold, it can be determined that the current image of the video meets the conditions of the complex image; when the second feature data is less than or equal to the second preset threshold, it can be determined that the current image of the video does not meet the conditions of the complex image.

If the image feature data includes the first feature data and the second feature data, when the first feature data is greater than the first preset threshold or when the second feature data is greater than the second preset threshold, or when the first feature data is greater than the first preset threshold and the second feature data is greater than the second preset threshold, it can be determined that the current image of the video meets the conditions of the complex image; when the first feature data is less than or equal to the first preset threshold, and the second feature data is less than or equal to the second preset threshold, it can be determined that the current image of the video does not meet the conditions of the complex image.

According to the video processing method provided by the present disclosure, a reference code rate is predicted based on the current image feature data of the video and the frame rate corresponding to the video, and the reference code rate is further adjusted according to the image feature data to obtain a target code rate, and the current code rate of the video is adjusted to the target code rate. Therefore, on the premise of making the speed and smoothness of encoding processing for the video more stable, the quality of the video image is further improved, and the utilization rate of image processing resources is further improved.

It should be noted that although in the above embodiment, the operations of the method of the embodiment of the present disclosure are described in a specific order, this does not require or imply that these operations must be performed in this specific order, or that all the illustrated operations must be performed to achieve the desired results. On the contrary, the execution order can be changed for the steps depicted in the flow diagram. Additionally or alternatively, it is possible to omit some steps, combine multiple steps into one step for execution, and/or decompose one step into multiple steps for execution.

Corresponding to the aforementioned embodiment of the video processing method, the present disclosure also provides an embodiment of a video processing apparatus.

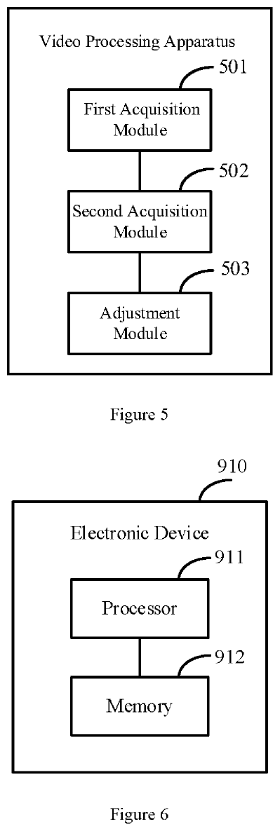

As shown in FIG. 5, FIG. 5 is a block diagram of a video processing apparatus shown according to an exemplary embodiment of the present disclosure. The apparatus can include: a first acquisition module 501, a second acquisition module 502 and an adjustment module 503.

The first acquisition module 501 is used for acquiring current image feature data of a video, wherein the image feature data represents the image complexity degree of the video.

The second acquisition module 502 is used for acquiring a frame rate corresponding to the video.

The adjustment module 503 is used for adjusting a current code rate of the video based on the above-mentioned image feature data and the above-mentioned frame rate, so that the current code rate of the video is positively correlated with the image complexity degree of the video.

In some implementations, the above-mentioned image feature data can include first feature data representing the current image complexity degree of the video, and/or second feature data representing the current image inter-frame variation degree of the video.

In some other implementations, if the above-mentioned image feature data includes the first feature data, the first acquisition module 501 can determine the first feature data by: acquiring a current frame of image of the video, and determining the first feature data based on the pixel value differences between a plurality of pixels and neighboring pixels in the current frame of image.

If the above-mentioned image feature data includes the second feature data, the first acquisition module 501 can determine the second feature data by: acquiring a current frame of image and a previous frame of image of the video, and determining the second feature data based on the pixel value differences between the pixels at the same position in the current frame of image and the previous frame of image.

In some other implementations, the adjustment module 503 can include: a determination sub-module, an acquisition sub-module and an adjustment sub-module (not shown in the figure).

The determination sub-module is used for determining a reference code rate based on the above-mentioned image feature data and the above-mentioned frame rate.

The acquisition submodule is used for adjusting the reference code rate according to the above-mentioned image feature data to obtain the target code rate.

The adjustment submodule is used for adjusting the current code rate of the video to the target code rate.

In some other implementations, the acquisition sub-module is configured to: determine whether the current image of the video meets the conditions of a complex image based on the above-mentioned image feature data; take the reference code rate as the target code rate when the current image does not meet the conditions of the complex image; increase the reference code rate at least when the current image meets the conditions of the complex image to obtain the target code rate.

In some other implementations, the acquisition sub-module can increase the reference code rate at least when the current image meets the conditions of the complex image to obtain the target code rate by: determining the data amount of the processed image corresponding to the video when the current image meets the conditions of the complex image; increasing the reference code rate to obtain the target code rate if the data amount of the processed image is less than or equal to the specified data amount.

In some other implementations, the acquisition sub-module can increase the reference code rate to obtain the target code rate by: determining a code rate increment based on the data amount of the processed image, and determining the sum of the reference code rate and the code rate increment as the target code rate, wherein the code rate increment is negatively correlated with the data amount of the processed image.

For the apparatus embodiment, because it basically corresponds to the method embodiment, the relevant points refer to part of the method embodiment. The apparatus embodiment described above is only schematic, in which the units described as separate components may or may not be physically separated, and the components displayed as units may or may not be physical units, that is, they may be located in one place or distributed to multiple network units. Part or all of the modules can be selected according to actual needs to achieve the purpose of the embodiment solution of the present disclosure. Those skilled in the art can understand and implement it without inventive effort.

FIG. 6 is a schematic block diagram of an electronic device provided by some embodiments of the present disclosure. As shown in FIG. 6, the electronic device 910 includes a processor 911 and a memory 912, which can be used to implement a client or a server. The memory 912 is used for non-transitorily storing computer-executable instructions (e.g., one or more computer program modules). The processor 911 is used for executing the computer-executable instructions, which, when executed by the processor 911, can perform one or more steps of the above-mentioned video processing method, thereby realizing the above-mentioned video processing method. The memory 912 and the processor 911 can be interconnected via a bus system and/or other forms of connection mechanisms (not shown).

For example, the processor 911 can be a central processing unit (CPU), a graphics processing unit (GPU) or other forms of processing units with data processing capability and/or program execution capability. For example, the central processing unit (CPU) can be X86 or ARM architecture. The processor 911 can be a general-purpose processor or a special-purpose processor, and can control other components in the electronic device 910 to perform desired functions.

For example, the memory 912 can include any combination of one or more computer program products, which can include various forms of computer-readable storage media, such as a volatile memory and/or a nonvolatile memory. The volatile memory can include, for example, a random access memory (RAM) and/or a cache, etc. The non-volatile memory can include, for example, a read-only memory (ROM), a hard disk, an erasable programmable read-only memory (EPROM), a portable compact disk read-only memory (CD-ROM), a USB memory, a flash memory, etc. One or more computer program modules can be stored on a computer-readable storage medium, and the processor 911 can execute one or more computer program modules to realize various functions of the electronic device 910. The computer-readable storage medium can also store various application programs and various data, as well as various data used and/or generated by the application programs, etc.

It should be noted that, in the embodiment of the present disclosure, the specific functions and technical effects of the electronic device 910 can refer to the above description about the video processing method, and will not be described here.

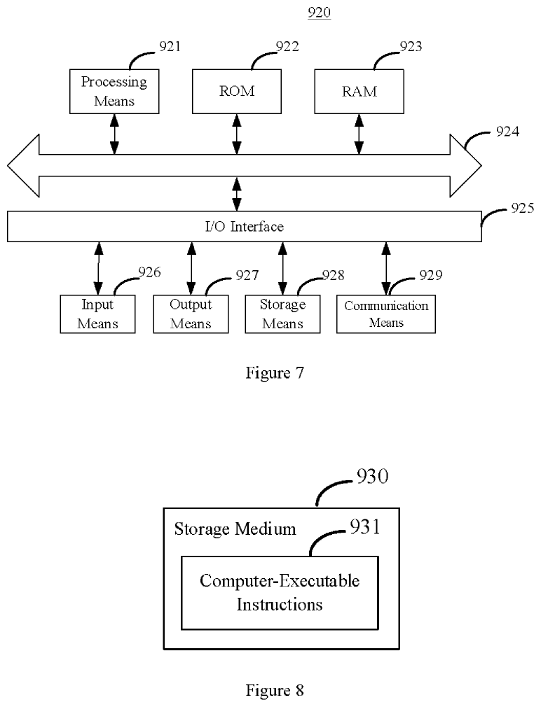

FIG. 7 is a schematic block diagram of another electronic device provided by some embodiments of the present disclosure. The electronic device 920 is, for example, suitable for implementing the video processing method provided by the embodiment of the present disclosure. The electronic device 920 can be a terminal device or the like, which can be used to implement a client or a server. The electronic device 920 can include, but is not limited to, mobile terminals such as a mobile phone, a notebook computer, a digital broadcast receiver, a Personal Digital Assistant (PDA), a Tablet Computer (PAD), a Portable Multimedia Player (PMP), a vehicle-mounted terminal (such as a vehicle navigation terminal), and a wearable electronic device, as well as fixed terminals such as a digital TV, a desktop computer, and a smart home device. It should be noted that the electronic device 920 shown in FIG. 7 is only an example, and it will not bring any limitations on the functions and use scope of the embodiments of the present disclosure.

As shown in FIG. 7, the electronic device 920 can include a processing means (such as a central processing unit, a graphics processor, etc.) 921, which can perform various appropriate actions and processes according to a program stored in a read-only memory (ROM) 922 or a program loaded from a storage means 928 onto a random access memory (RAM) 923. In the RAM 923, various programs and data required for the operation of the electronic device 920 are also stored. The processing means 921, the ROM 922 and the RAM 923 are connected to each other via a bus 924. An input/output (I/O) interface 925 is also connected to the bus 924.

Generally, the following means can be connected to the I/O interface 925: an input means 926 including, for example, a touch screen, a touch pad, a keyboard, a mouse, a camera, a microphone, an accelerometer, and a gyroscope; an output means 927 including, for example, a liquid crystal display (LCD), a speaker, and a vibrator; a storage means 928 including, for example, a magnetic tape, and a hard disk; and a communication means 929. The communication means 929 can allow the electronic device 920 to perform wireless or wired communication with other electronic devices to exchange data. Although FIG. 7 shows an electronic device 920 having various means, it should be understood that not all the means shown are required to be implemented or provided, and the electronic device 920 can be implemented or provided with more or less means instead.

For example, according to an embodiment of the present disclosure, the above-mentioned video processing method can be implemented as a computer software program. For example, an embodiment of the present disclosure includes a computer program product including a computer program carried on a non-transient computer-readable medium, and the computer program includes program codes for executing the above-mentioned video processing method. In such an embodiment, the computer program can be downloaded and installed from the network through the communication means 929, or installed from the storage means 928 or from the ROM 922. When the computer program is executed by the processing means 921, the functions defined in the video processing method provided by the embodiment of the present disclosure can be realized.

FIG. 8 is a schematic diagram of a storage medium provided by some embodiments of the present disclosure. For example, as shown in FIG. 8, the storage medium 930 can be a non-transitory computer-readable storage medium for storing non-transitory computer-executable instructions 931. When the non-transitory computer-executable instructions 931 are executed by a processor, the video processing method described in the embodiment of the present disclosure can be implemented. For example, when the non-transitory computer-executable instructions 931 are executed by a processor, one or more steps of the video processing method described above can be performed.

For example, the storage medium 930 can be applied to the above-mentioned electronic device, and for example, the storage medium 930 can include a memory in the electronic device.

For example, the storage medium can include a memory card of a smart phone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, any combination of the above storage media, or other suitable storage media.

For example, the description of the storage medium 930 can refer to the description of the memory in the embodiment of the electronic device, and the repetition is not repeated here. The specific functions and technical effects of the storage medium 930 can refer to the above description of the video processing method, and will not be repeated here.

It should be noted that in the context of the present disclosure, a computer-readable medium can be a tangible medium, which can contain or store a program for use by or in combination with an instruction execution system, apparatus or device. The computer-readable medium can be a computer-readable signal medium or a computer-readable storage medium or any combination of the two. The computer-readable storage medium can be, for example, but not limited to: an electrical, magnetic, optical, electromagnetic, infrared, or semiconductor system, apparatus or device, or any combination of the above. More specific examples of the computer-readable storage medium can include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium containing or storing a program, which can be used by or in combination with an instruction execution system, apparatus or device. In the present disclosure, the computer-readable signal medium can include a data signal propagated in baseband or as part of a carrier wave, in which computer-readable program codes are carried. This propagated data signal can take many forms, including but not limited to an electromagnetic signal, an optical signal or any suitable combination of the above. The computer-readable signal medium can also be any computer-readable medium other than the computer-readable storage medium, which can send, propagate or transmit a program for use by or in connection with an instruction execution system, apparatus or device. The program codes contained in the computer-readable medium can be transmitted by any suitable medium, including but not limited to: wires, optical cables, RF (radio frequency) and the like, or any suitable combination of the above.

Other implementations of the present disclosure will easily occur to those skilled in the art after considering the Specification and practicing the invention disclosed herein. The present disclosure is intended to cover any variations, uses or adaptive changes of the present disclosure, which follow the general principles of the present disclosure and include common sense or customary technical means in this technical field that are not disclosed in the present disclosure. The Specification and embodiments are to be regarded as exemplary only, with the true scope and spirit of the disclosure being indicated by the claims.

It should be understood that the present disclosure is not limited to the precise structure described above and shown in the drawings, and various modifications and changes can be made without departing from its scope. The scope of the present disclosure is limited only by the appended claims.

1. A video processing method, the method comprising:
acquiring current image feature data of a video, wherein the image feature data represents an image complexity degree of the video;
acquiring a frame rate corresponding to the video; and
adjusting a current code rate of the video based on the image feature data and the frame rate, so that the current code rate of the video is positively correlated with the image complexity degree of the video.

2. The method according to claim 1, wherein the image feature data comprises at least one of first feature data representing a current image complexity degree of the video or second feature data representing a current image inter-frame variation degree of the video.

3. The method according to claim 2, wherein if the image feature data comprises the first feature data, the first feature data is determined by: acquiring a current frame of image of the video, and determining the first feature data based on pixel value differences between a plurality of pixels and neighboring pixels in the current frame of image;
wherein if the image feature data comprises the second feature data, the second feature data is determined by: acquiring the current frame of image and a previous frame of image of the video, and determining the second feature data based on pixel value differences between the pixels at the same position in the current frame and the previous frame.

4. The method according to claim 1, wherein the adjusting the current code rate of the video based on the image feature data and the frame rate comprises:
determining a reference code rate based on the image feature data and the frame rate;
adjusting the reference code rate according to the image feature data to obtain a target code rate; and
adjusting the current code rate of the video to the target code rate.

5. The method according to claim 4, wherein the adjusting the reference code rate according to the image feature data to obtain the target code rate comprises:
determining whether the current image of the video meets conditions of a complex image based on the image feature data;
taking the reference code rate as the target code rate when the current image does not meet the conditions of the complex image; and
increasing the reference code rate at least when the current image meets the conditions of the complex image to obtain the target code rate.

6. The method according to claim 5, wherein the increasing the reference code rate at least when the current image meets the conditions of the complex image to obtain the target code rate comprises:
determining data amount of one or more processed images corresponding to the video when the current image meets the conditions of the complex image; and
increasing the reference code rate to obtain the target code rate if the data amount of the one or more processed images is less than or equal to a specified data amount.

7. The method according to claim 6, wherein the increasing the reference code rate to obtain the target code rate comprises:
determining a code rate increment based on the data amount of the one or more processed images, wherein the code rate increment is negatively correlated with the data amount of the one or more processed image; and
determining a sum of the reference code rate and the code rate increment as the target code rate.

8. (canceled)

9. A non-transitory computer-readable storage medium having a computer program stored thereon, which, when executed in a computer, causes the computer to perform a video processing method comprising:
acquiring current image feature data of a video, wherein the image feature data represents an image complexity degree of the video;
acquiring a frame rate corresponding to the video; and
adjusting a current code rate of the video based on the image feature data and the frame rate, so that the current code rate of the video is positively correlated with the image complexity degree of the video.

10. An electronic device, comprising a memory and a processor, wherein the memory has executable codes stored therein, which, when executed by the processor, implement a video processing method comprising:
acquiring current image feature data of a video, wherein the image feature data represents an image complexity degree of the video;
acquiring a frame rate corresponding to the video; and
adjusting a current code rate of the video based on the image feature data and the frame rate, so that the current code rate of the video is positively correlated with the image complexity degree of the video.

11. (canceled)

12. The non-transitory computer-readable storage medium according to claim 9, wherein the image feature data comprises at least one of first feature data representing a current image complexity degree of the video or second feature data representing a current image inter-frame variation degree of the video.

13. The non-transitory computer-readable storage medium according to claim 12, wherein if the image feature data comprises the first feature data, the first feature data is determined by:
acquiring a current frame of image of the video, and determining the first feature data based on pixel value differences between a plurality of pixels and neighboring pixels in the current frame of image;
wherein if the image feature data comprises the second feature data, the second feature data is determined by: acquiring the current frame of image and a previous frame of image of the video, and determining the second feature data based on pixel value differences between the pixels at the same position in the current frame and the previous frame.

14. The non-transitory computer-readable storage medium according to claim 9, wherein the adjusting the current code rate of the video based on the image feature data and the frame rate comprises:
determining a reference code rate based on the image feature data and the frame rate;
adjusting the reference code rate according to the image feature data to obtain a target code rate; and
adjusting the current code rate of the video to the target code rate.

15. The non-transitory computer-readable storage medium according to claim 14, wherein the adjusting the reference code rate according to the image feature data to obtain the target code rate comprises:
determining whether the current image of the video meets conditions of a complex image based on the image feature data;
taking the reference code rate as the target code rate when the current image does not meet the conditions of the complex image; and
increasing the reference code rate at least when the current image meets the conditions of the complex image to obtain the target code rate.

16. The non-transitory computer-readable storage medium according to claim 15, wherein the increasing the reference code rate at least when the current image meets the conditions of the complex image to obtain the target code rate comprises:
determining data amount of one or more processed images corresponding to the video when the current image meets the conditions of the complex image; and
increasing the reference code rate to obtain the target code rate if the data amount of the one or more processed images is less than or equal to a specified data amount.

17. The non-transitory computer-readable storage medium according to claim 16, wherein the increasing the reference code rate to obtain the target code rate comprises:
determining a code rate increment based on the data amount of the one or more processed images, wherein the code rate increment is negatively correlated with the data amount of the one or more processed image; and
determining a sum of the reference code rate and the code rate increment as the target code rate.

18. The electronic device according to claim 10, wherein the image feature data comprises at least one of first feature data representing a current image complexity degree of the video or second feature data representing a current image inter-frame variation degree of the video.

19. The electronic device according to claim 18, wherein if the image feature data comprises the first feature data, the first feature data is determined by: acquiring a current frame of image of the video, and determining the first feature data based on pixel value differences between a plurality of pixels and neighboring pixels in the current frame of image;
wherein if the image feature data comprises the second feature data, the second feature data is determined by: acquiring the current frame of image and a previous frame of image of the video, and determining the second feature data based on pixel value differences between the pixels at the same position in the current frame and the previous frame.

20. The electronic device according to claim 10, wherein the adjusting the current code rate of the video based on the image feature data and the frame rate comprises:
determining a reference code rate based on the image feature data and the frame rate;
adjusting the reference code rate according to the image feature data to obtain a target code rate; and
adjusting the current code rate of the video to the target code rate.

21. The electronic device according to claim 20, wherein the adjusting the reference code rate according to the image feature data to obtain the target code rate comprises:
determining whether the current image of the video meets conditions of a complex image based on the image feature data;
taking the reference code rate as the target code rate when the current image does not meet the conditions of the complex image; and
increasing the reference code rate at least when the current image meets the conditions of the complex image to obtain the target code rate.

22. The electronic device according to claim 21, wherein the increasing the reference code rate at least when the current image meets the conditions of the complex image to obtain the target code rate comprises:
determining data amount of one or more processed images corresponding to the video when the current image meets the conditions of the complex image; and
increasing the reference code rate to obtain the target code rate if the data amount of the one or more processed images is less than or equal to a specified data amount.
